(19) United States
(12) Patent Application Publication
(10) Pub. No.: US 2025/0389899 A1
(43) Pub. Date: Dec. 25, 2025

(54) ADAPTER FOR OPTICAL FIBER CONNECTORS

(71) Applicant: Microsoft Technology Licensing, LLC, Redmond, WA (US)

(72) Inventors: William David BRAGG, Redmond, WA (US); Hugh David Paul WILLIAMS, Cambridge (GB); David Anthony SWEENEY, Cratloe (IE); David James RICHARDSON, St Ives (GB); Tae Woo HONG, London (GB); Elliott Louis HOGG, Manningtree (GB); Iason SARANTOPOULOS, Cambridge (GB); Antony Ian Taylor ROWSTRON, Cambridge (GB); Andromachi CHATZIELEFTHERIOU, Cambridge (GB)

(73) Assignee: Microsoft Technology Licensing, LLC, Redmond, WA (US)

(21) Appl. No.: 18/758,528

(22) Filed: Jun. 28, 2024

Related U.S. Application Data
(60) Provisional application No. 63/664,116, filed on Jun. 25, 2024.

(51) Int. Cl. G02B 6/38

(52) U.S. Cl. CPC G02B 6/3825; G02B 6/3883; G02B 6/3885; G02B 6/3893

(57) ABSTRACT

An adapter for securing a plurality of configurations of optical fiber connectors comprises a main body and a stop face in the main body that engages with a first configuration of connector to secure the connector in the adapter. A slider body is moveably coupled to the main body. As a second configuration of optical fiber connector is inserted into the main body, the second configuration moves the slider body toward the main body, thereby securing the second configuration of optical fiber connector in the adapter.

### CROSS REFERENCE TO RELATED APPLICATIONS

This application claims priority to U.S. Provisional patent application Ser. No. 63/664,116, filed Jun. 25, 2024, the entirety of which is hereby incorporated herein by reference for all purposes.

### BACKGROUND

Optical fiber connectors are available in many different configurations and form factors.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed and further described below that relate to adapters and related methods for securing a plurality of configurations of optical fiber connectors. In one example and as described below, an adapter comprises a main body including a stop face that engages with a first configuration of optical fiber connector to secure the first configuration of optical fiber connector in the adapter. A slider body is moveably coupled to the main body. As a second configuration of optical fiber connector is inserted into the main body, the second configuration of optical fiber connector moves the slider body toward the main body, thereby securing the second configuration of optical fiber connector in the adapter.

Another example provides a method for securing a plurality of configurations of optical fiber connectors into an adapter. A first configuration of optical fiber connector is received in a front side of the adapter. In response to receiving the first configuration of connector, the first configuration of connector is secured in the adapter. A second configuration of optical fiber connector is received in the front side of the adapter. In response to receiving the second configuration of optical fiber connector, the second configuration of optical fiber connector is secured in the adapter.

### BRIEF DESCRIPTION OF THE DRAWINGS

FIG. 1 shows a front side view of one example of an adapter for securing a plurality of configurations of optical fiber connectors, along with partial views of first and second configurations of optical fiber connectors and an optical fiber cleaning instrument, according to the present disclosure.

FIG. 2 shows a rear side view of the adapter of FIG. 1.

FIG. 3 shows the cleaning instrument inserted in an instrument receiving opening of the adapter in a first position according to examples of the present disclosure.

FIG. 4 shows the cleaning instrument inserted in the instrument receiving opening in a second position according to examples of the present disclosure.

FIG. 5 shows an exploded view of the adapter of FIG. 1.

FIG. 6 shows a first configuration of optical fiber connector and the cleaning instrument inserted into the adapter of FIG. 1.

FIG. 7 shows a partial cross-section view taken along lines 7-7 in FIG. 1 along with a portion of a Lucent Connector (LC) optical fiber connector.

FIG. 8 shows a partial cross-section view taken along lines 8-8 in FIG. 6.

FIG. 9 shows a partial cross-section view taken along lines 9-9 in FIG. 6.

FIG. 10 shows the partial cross-section view of the adapter of FIG. 7 along with a portion of a Multi-fiber Push On (MPO) optical fiber connecter.

FIG. 11 shows the MPO optical fiber connector partially inserted into the adapter.

FIG. 12 shows the MPO optical fiber connector fully inserted and secured in the adapter.

FIGS. 13A and 13B are a flow chart of a method for securing a plurality of configurations of optical fiber connectors into an adapter according to examples of the present disclosure.

### DETAILED DESCRIPTION

Optical fiber connectors are utilized to mate optical fibers in a variety of applications and for a variety of purposes. As noted above, a wide variety of optical fiber connectors having many different configurations and form factors are available. A number of different instruments are utilized to inspect, test, and/or clean optical fiber connectors during manufacturing and in the field prior to connection. For example, a microscope can be utilized to inspect the connector for contaminants or blemishes. End-to-end losses can be tested using a power meter and light source. An optical time-domain reflectometer can be utilized to characterize the optical fiber and identify point and/or return losses. Optical fiber cleaning instruments can be used to clean the end-face of optical fiber connectors.

Each instrument needs to be properly connected to and/or aligned with the optical fiber connector. Given the wide variety of connector configurations and form factors, typically a separate adapter is required for each different optical fiber configuration to connect/align with a desired instrument. Accordingly, where a user or technician is working with multiple different types of optical fiber connecters, the user or technician must separately install a different corresponding adapter for each type of fiber optic connector. Locating and installing a different adapter for each different configuration of optical fiber connector increases the time required for the testing and/or cleaning processes, and increases the chances for mishandling adapter installation and introducing contaminants and/or damaging the optical fiber connector. Further, maintaining an extensive inventory of different adapters for each different type of optical fiber connector increases costs.

Accordingly and as described in more detail below, the present disclosure describes adapters and corresponding methods that advantageously accept and secure a plurality of configurations of optical fiber connectors. Further, adapters of the present disclosure also accept and guide the insertion of an instrument for use with a secured optical fiber connector. Advantageously, utilizing adapters of the present disclosure enables a technician or automated device to interact with multiple different configurations of optical fiber connectors without the need for multiple different adapters, thereby avoiding the disadvantages and risks described above.

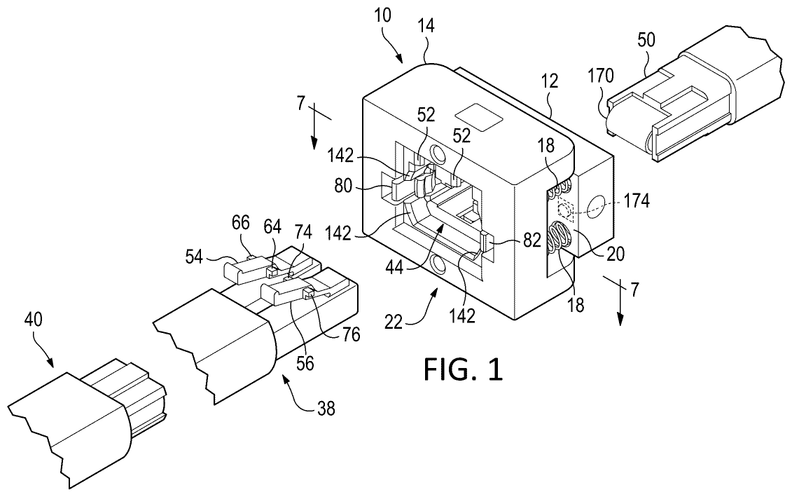

FIGS. 1-12 show one example of an adapter 10 for securing a plurality of configurations of optical fiber connectors according to aspects of the present disclosure. In the present example and as described in more detail below, the adapter 10 is configured to receive and secure a first configuration of optical fiber connector in the form of a Lucent Connector (LC) configuration and a second configuration of optical fiber connector in the form of a Multi-fiber Push On (MPO) configuration. It will be appreciated that the principles of the present disclosure can be utilized in other configurations of adapters that receive and secure other types and configurations of optical fiber connectors having different form factors, capabilities, components, and/or other features.

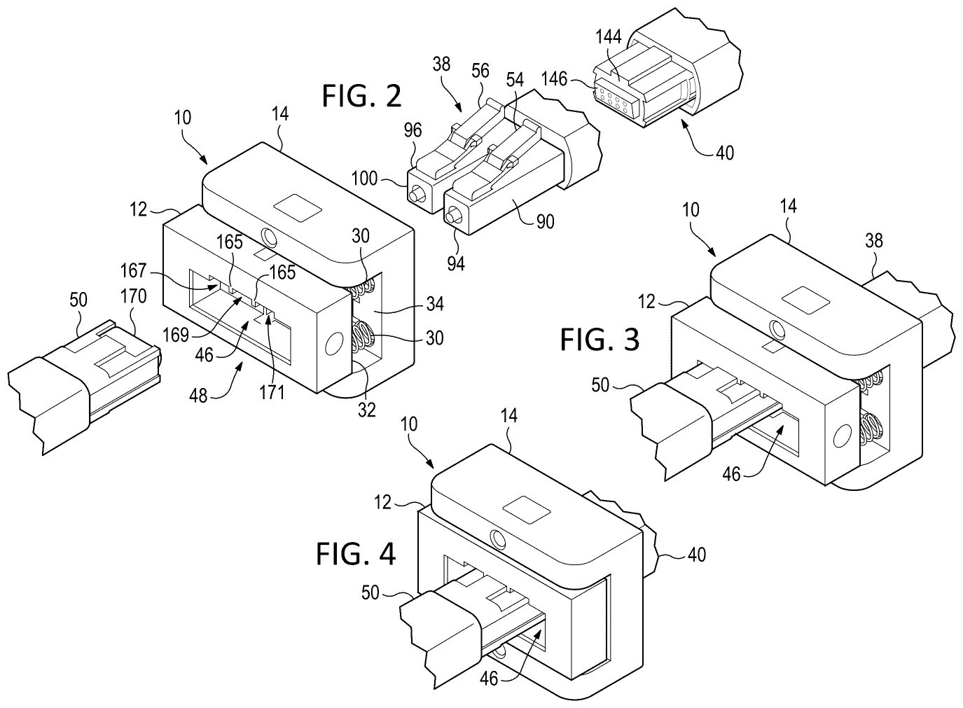

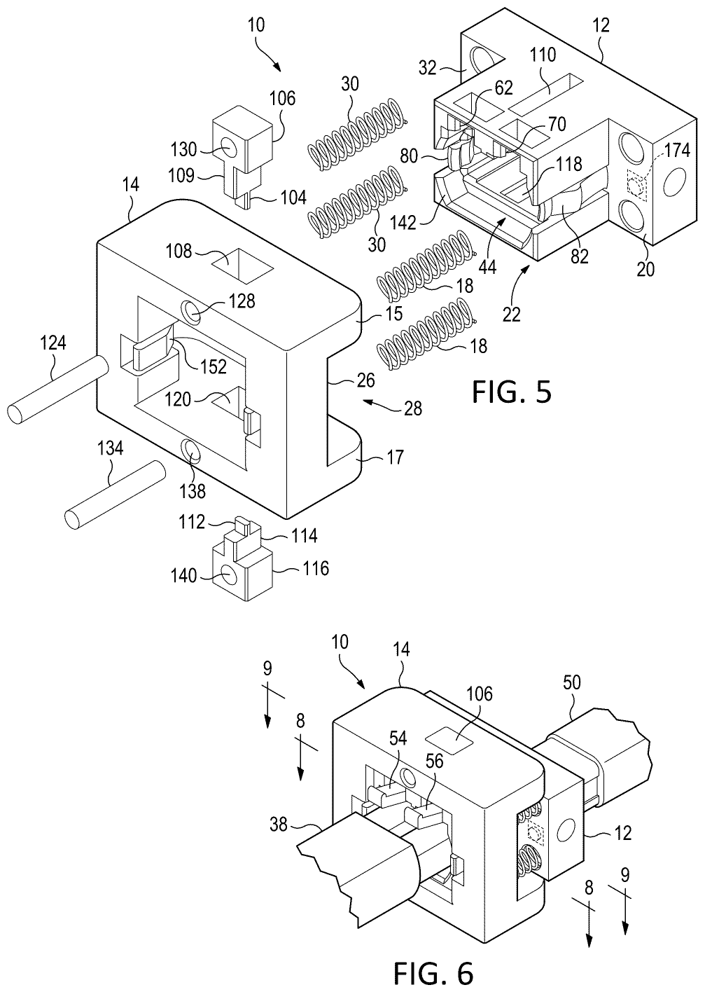

In the present example and with reference to FIGS. 1 and 2, the adapter 10 comprises a main body 12 and a slider body 14 that is moveably coupled to the main body. A biaser moveably couples the main body 12 to the slider body 14 and biases the slider body away from the main body. In this example and with reference also to FIG. 5, the biaser comprises two compression springs 18 that extend between a first front face 20 on a front side 22 of the main body 12 and a first rear face 26 on a rear side 28 of the slider body, and two compression springs 30 that extend between a second front face 32 on the front side 22 of the main body 12 and a second rear face 34 on the rear side 28 of the slider body. In other examples, different configurations and types of biasers can be utilized to bias the slider body 14 away from the main body 12, including but not limited to other types of spring(s), elastomeric member(s), and sprung steel. In other examples, the slider body and main body comprise a single component linked together compliantly to enable relative movement.

As described in more detail below, and in one potential advantage of the present disclosure, moveably coupling the slider body 14 to the main body 12 enables a configuration in which the slider body selectively engages with one configuration of optical fiber connector and moves toward the main body as the connector is inserted. As described further below, such movement of the slider body 14 causes opposing snap fit arms in the main body 12 to move toward one another and to secure this configuration of optical fiber connector in the adapter.

With reference again to FIG. 1 and as noted above, adapter 10 is configured to separately receive and secure an LC optical fiber connector 38 and an MPO optical fiber connector 40 in a main fiber receiving opening 44 defined in the front side 22 of the main body 12. FIG. 1 shows portions of an LC optical fiber connector 38 and MPO optical fiber connector 40. Additionally and with reference to FIGS. 2-4, adapter 10 is configured to receive one or more instruments in an instrument receiving opening 46 defined in a rear side 48 of the main body 12 opposite to the front side 22. In the present example and as described in more detail below, adapter 10 can receive an optical fiber cleaning instrument 50 in the instrument receiving opening 46.

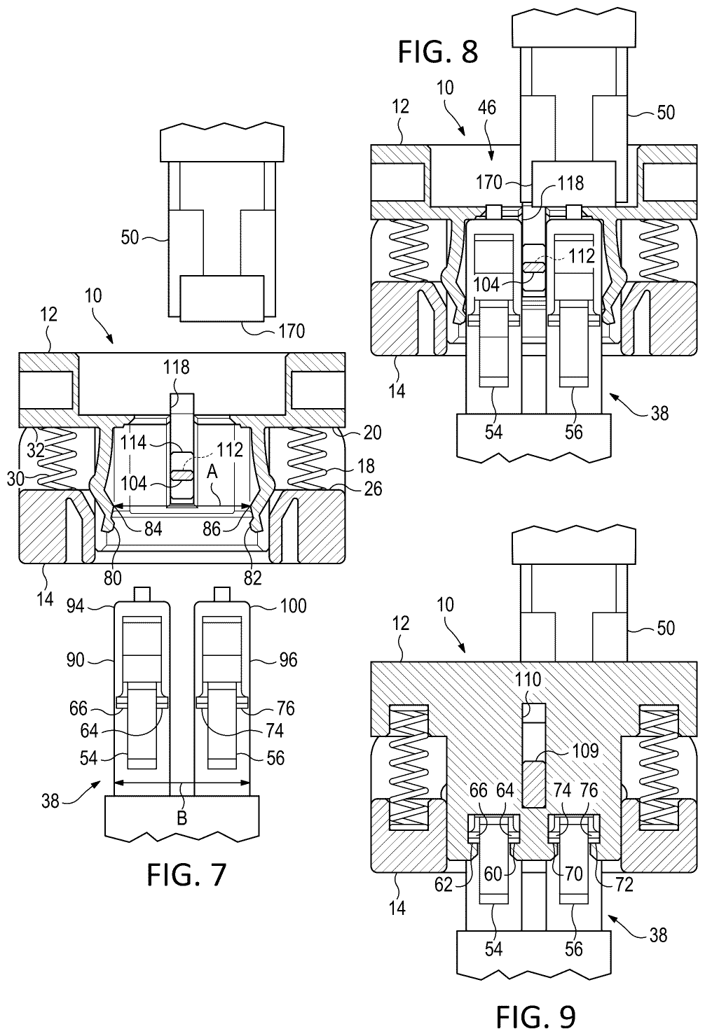

In one use case, adapter 10 receives and secures an LC optical fiber connector. In different examples, adapter 10 can receive simplex and duplex LC optical fiber connectors. With reference now to FIGS. 1 and 6-9, one example of receiving and securing a duplex LC optical fiber connector 38 is shown. FIGS. 1 and 7 show the LC optical fiber connector 38 aligned for insertion into the adapter 10. FIGS. 6, 8 and 9 show the LC optical fiber connector 38 fully inserted and secured in the adapter 10. As shown in FIG. 8, when the LC optical fiber connector 38 is secured in the adapter 10, the fiber ends of this connector protrude slightly into the instrument receiving opening to provide access to these fiber ends by one or more instruments.

In this example, FIG. 8 illustrates a cleaning ribbon 170 of the optical fiber cleaning instrument 50 contacting the fiber end extending from the second housing 100, and the optical fiber cleaning instrument is an MPO optical fiber cleaning instrument. In another potential advantage of the present disclosure, and as described in more detail below, this configuration can receive the MPO optical fiber cleaning instrument 50 in a variety of lateral positions in the instrument receiving opening 46 to enable the apparatus to clean both LC optical fiber connectors and MPO optical fiber connectors.

The main body 12 comprises first alignment features that guide an LC optical fiber connector 38 into the main body. In this example and with reference to FIG. 1, the first alignment features include upper chamfered edges 52 that guide the LC optical fiber connector 38 as it is inserted into the main fiber receiving opening 44.

The LC optical fiber connector 38 includes a first compliant arm 54 and a second compliant arm 56. The main body 12 of adapter 10 includes a first securing feature that engages with the first compliant arm 54 of the LC optical fiber connector 38 to secure the connector in the adapter. In this example and as best seen in FIG. 9, the first securing feature comprises a first inner stop face 60 and a first outer stop face 62 that each abut a first inner laterally extending tab 64 and a first outer laterally extending tab 66, respectively, of the first compliant arm 54 when the LC optical fiber connector 38 is fully seated in the adapter 10. In this manner, the first inner stop face 60 and first outer stop face 62 secure the LC optical fiber connector 38 in the adapter and prevent the connector from being pulled from the adapter.

Similarly, the main body 12 of adapter 10 includes a second securing feature that engages with the second compliant arm 56 of the LC optical fiber connector 38 to secure the connector in the adapter. The second securing feature comprises a second inner stop face 70 and a second outer stop face 72 that each abut a second inner laterally extending tab 74 and a second outer laterally extending tab 76, respectively, of the second compliant arm when the LC optical fiber connector 38 is fully seated in the adapter 10. In this manner, the second inner stop face 70 and second outer stop face 72 also secure the LC optical fiber connector 38 in the adapter and prevent the connector from being pulled from the adapter.

With reference also to FIG. 5, to remove a seated LC optical fiber connector 38 from the adapter 10, a user presses downwardly on the first compliant arm 54 and second compliant arm 56 to correspondingly move downwardly the first inner laterally extending tab 64, first outer laterally extending tab 66, second inner laterally extending tab 74, and second outer laterally extending tab 76 away from the corresponding inner and outer stop faces to allow the connector to be removed from the adapter.

As noted above and in one potential advantage of the present disclosure, adapter 10 is also configured to receive and secure an MPO optical fiber connector. As described further below, the slider body 14 is moveably coupled to the main body 12 to enable the slider body to engage with an MPO optical fiber connector and move toward the main body as the connector is inserted. Such movement of the slider body 14 causes opposing snap fit arms in the main body 12 to move toward one another and to secure the optical fiber connector in the adapter.

As shown in FIGS. 1, 5, and 10-12, main body 12 includes a first snap fit arm 80 and an opposing second snap fit arm 82 that each extend away from the first front face 20 and second front face 32, respectively, of the main body. With reference to FIG. 7, in this example the distance A between the closest inner facing surfaces 84, 86 of the first snap fit arm 80 and the opposing second snap fit arm 82, respectively, is approximately equal to the distance B between the outer opposing surfaces 90, 96 of the first housing 94 and second housing 100, respectively, of the duplex LC optical fiber connecter 38. For purposes of the present disclosure, the distance B is referred to as the width of a duplex LC optical fiber connector 38.

In this manner and as shown in FIG. 8, the duplex LC optical fiber connector 38 can be easily inserted in between the first snap fit arm 80 and opposing second snap fit arm 82. In other examples the distance A can be greater than the distance B. In other examples the distance A can be slightly less than the distance B, such that the first snap fit arm 80 and opposing second snap fit arm 82 are bowed slightly outwardly when a duplex LC optical fiber connector 38 is inserted.

As noted above, the slider body 14 is moveably coupled to the main body 12 to enable the slider body to engage with an MPO optical fiber connector 40 and move toward the main body 12 as the connector is inserted. As described further below, during insertion the MPO optical fiber connector 40 contacts a slider arm that is affixed to the slider body 14 to cause the slider body to move with the connector toward the main body 12.

With reference now to FIG. 5, in the present example a first slider arm 104 is affixed to the slider body by positioning the first slider arm base 106 within a first aperture 108 defined in an upper lobe 15 of the slider body 14. A first extension member 109 extends between the first slider arm base 106 and the first slider arm 104 and through a first slider arm slot 110 defined in the main body 12 to position the first slider arm in the path of travel of the MPO optical fiber connector 40 (as described further below). A first pin 124 extends through a first slider body bore 128 in the upper lobe 15 of slider body 14 and a first slider arm base bore 130 in the first slider arm base 106 to secure the first slider arm base 106 and first slider arm 104 to the slider body.

In this example and as shown in FIG. 5, adapter 10 also utilizes a second slider arm 112 that is affixed to the slider body 14 by positioning the second slider arm base 116 within a second aperture 120 defined in a lower lobe 17 of the slider body 14. A second extension member 114 extends between the second slider arm base 116 and the second slider arm 112 and through a second slider arm slot 118 defined in the main body 12 to position the first slider arm in the path of travel of the MPO optical fiber connector 40 (as described further below). A second pin 134 extends through a second slider body bore 138 in lower lobe 17 of slider body 14 and a second slider arm base bore 140 in the second slider arm base 116 to secure the second slider arm base 116 and second slider arm 112 to the slider body.

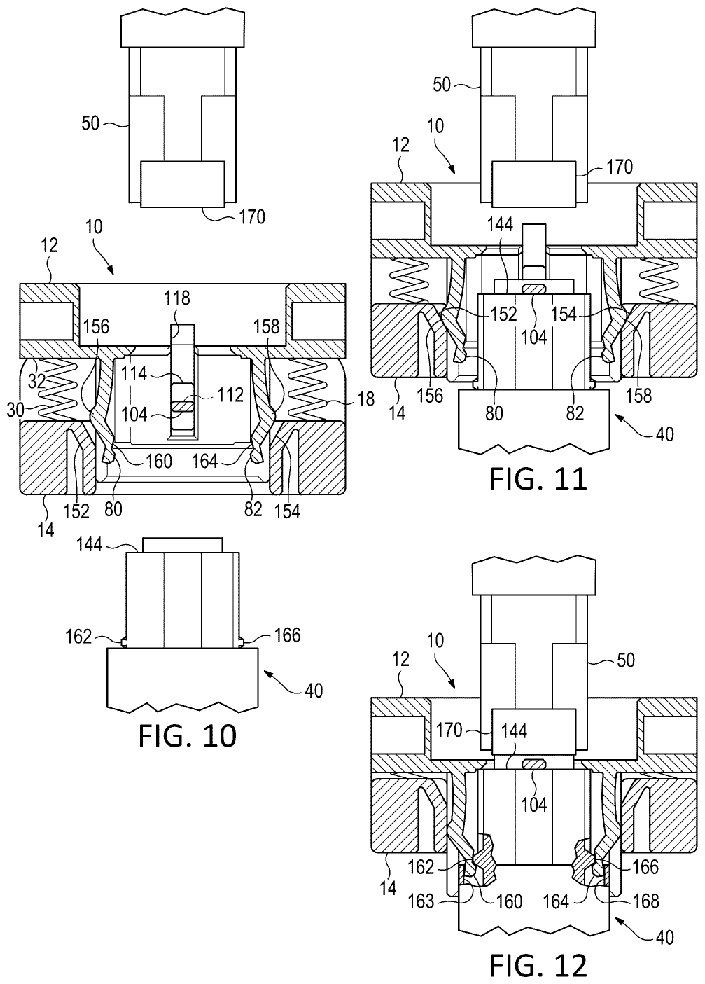

Insertion of an MPO optical fiber connector 40 into adapter 10 will now be described. With reference to FIGS. 1 and 5, second alignment features in the form of curved chamfered edges 142 guide the MPO optical fiber connector 40 into the main body 12. With reference now to FIGS. 10-12, FIG. 10 illustrates a partial cross-section view of the adapter along with a portion of an MPO optical fiber connecter 40. FIG. 11 shows the MPO optical fiber connector 40 partially inserted into adapter 10. Comparing FIGS. 10 and 11 it will be seen that in FIG. 11 the front face 144 of the MPO optical fiber connector 40 has contacted the first slider arm 104 (affixed to slider body 14) and second slider arm 112 (not shown) and translated the first and second slider arms and slider body toward the main body 12. Correspondingly and with reference also to FIG. 5, in FIG. 11 a first ramp 152 of slider body 14 is contacting a first elbow feature 156 of the first snap fit arm 80, and an opposing second ramp 154 of the slider body is contacting a second elbow feature 158 of the second snap fit arm 82.

With reference now to FIG. 12, as the MPO optical fiber connector 40 and slider body 14 advance toward the main body 12 from the position in FIG. 11, the first ramp 152 and second ramp 154 move the first snap fit arm 80 and opposing second snap fit arm 82 toward each other to thereby reduce the distance between the two arms. In another potential advantage of the present disclosure, moving the first snap fit arm 80 and opposing second snap fit arm 82 toward each other enables the first distal end 160 of the first snap fit arm to slide and seat between a first protrusion 162 and a first opposing capture surface 163 in the MPO optical fiber connector 40, and enables the second distal end 164 of the second snap fit arm to slide and seat between a second protrusion 166 and a second opposing capture surface 168 in the MPO optical fiber connector. In this manner, the first snap fit arm 80 and opposing second snap fit arm 82 secure the MPO optical fiber connector 40 in the adapter 10.

Additionally, in another potential advantage of the present disclosure and with reference again to FIGS. 5 and 7-9, the first slider arm 104 and second slider arm 112 are positioned to allow a simplex or duplex LC optical fiber connecter to pass by the slider arms as the connector is inserted. Alternatively expressed, neither the first slider arm 104 nor the second slider arm 112 contacts an LC optical fiber connecter when the connector is inserted into the adapter. As can be seen in FIGS. 7 and 8, the first housing 94 and second housing 100 of LC optical fiber connector 38 pass by either side of the first slider arm 104 (and second slider arm 112) Advantageously, this configuration enables an LC optical fiber connector 38 to enter and fully seat within the adapter 10.

As noted above, adapter 10 is configured to receive one or more instruments in an instrument receiving opening 46 defined in a rear side 48 of the main body 12. In the present example, the adapter 10 is configured to receive an MPO optical fiber cleaning instrument 50 comprising a cleaning ribbon 170. In another potential advantage of the present disclosure, this configuration can receive the MPO optical fiber cleaning instrument 50 in a variety of lateral positions in the instrument receiving opening 46 to enable the apparatus to clean both LC optical fiber connectors and MPO optical fiber connectors.

More particularly and with reference again to FIGS. 2-4, in the present example main body 12 includes a plurality of instrument alignment features comprising downwardly depending members 165 that define a left slot 167, middle slot 169, and right slot 171 in an upper portion of the instrument receiving opening 46. As shown in FIG. 3, when an LC optical fiber connector 38 is seated in adapter 10, the MPO optical fiber cleaning instrument 50 can be inserted in the left slot 167 to align the cleaning ribbon 170 with the fiber end of the second housing 100. Once this fiber end has been cleaned, the optical fiber cleaning instrument 50 can be inserted in the right slot 171 to align the cleaning ribbon 170 with the fiber end of the first housing 94 and allow cleaning of this fiber end.

Additionally, and as shown in FIG. 4, when an MPO optical fiber connector 40 is seated in the adapter 10, the optical fiber cleaning instrument 50 can be inserted in the middle slot 169 to align the cleaning ribbon 170 with the fiber ends of this connector and enable these fiber ends to be cleaned. Advantageously and in this manner, this configuration enables a single cleaning instrument 50 (in this example an MPO optical fiber cleaning instrument) to clean both LC optical fiber connectors and MPO optical fiber connectors, thereby eliminating the need for a second, different cleaning instrument and the corresponding additional time required to exchange cleaning instruments and associated expense.

In some examples adapter 10 includes a switch that is activated by movement of the slider body 14 toward the main body 12 to indicate which type of optical fiber connector has been inserted. For example and with reference to FIGS. 5 and 6, a normally-open contact switch 174 can be located on the first front face 20 of the main body 12. As an MPO optical fiber connector 40 is inserted into the main body 12, the connector moves the slider body 14 toward the main body until the slider body contacts and closes the switch 174. A signal from the switch 174 is provided to an electronic component (not shown), such as a power meter, to indicate that an MPO optical fiber connector 40 has been inserted. Advantageously and utilizing the signal, the electronic component can perform predetermined operations corresponding to insertion of an MPO optical fiber connector 40, such as procedures tailored to cleaning such a connector. In other examples and configurations, a variety of other switches and sensing elements can be utilized and located in any other suitable location on adapter 10.

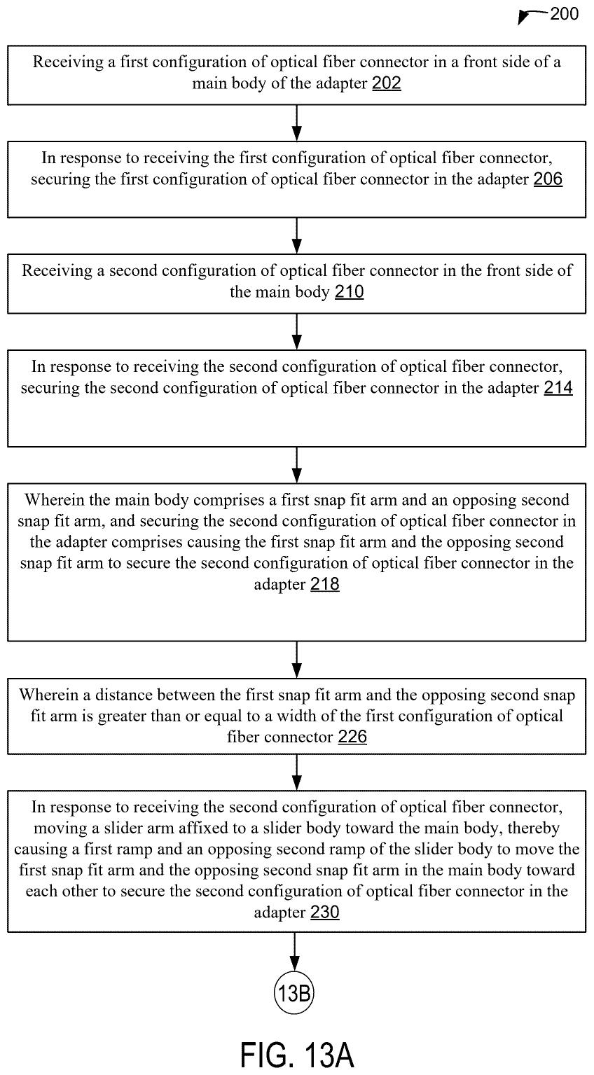

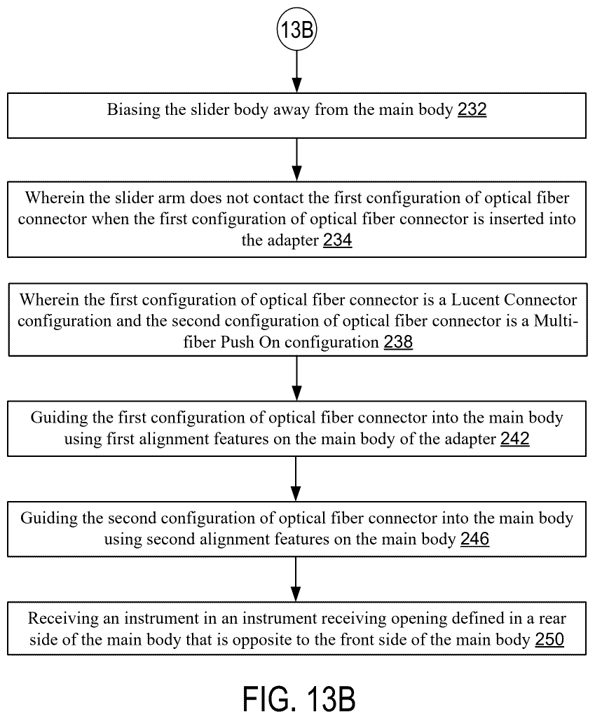

With reference now to FIGS. 13A and 13B, a flow diagram is provided depicting an example method 200 for securing a plurality of configurations of optical fiber connectors into an adapter. The following description of method 200 is provided with reference to the configurations and components described herein and shown in FIGS. 1-12. In other examples, method 200 can be performed with other configurations of adapters and in other contexts using other suitable components.

The following description of method 200 is provided by way of example and is not meant to be limiting. Therefore, it is to be understood that method 200 may include additional and/or alternative steps relative to those illustrated in FIGS. 13A and 13B. Further, it is to be understood that the steps of method 200 may be performed in any suitable order. Further still, it is to be understood that one or more steps may be omitted from method 200 without departing from the scope of this disclosure. It will also be appreciated that method 200 also may be performed in other contexts using other suitable components

At 202 method 200 includes receiving a first configuration of optical fiber connector in a front side of a main body of the adapter. At 206 method 200 includes, in response to receiving the first configuration of optical fiber connector, securing the first configuration of optical fiber connector in the adapter. At 210 method 200 includes receiving a second configuration of optical fiber connector in the front side of the main body. At 214 method 200 includes, in response to receiving the second configuration of optical fiber connector, securing the second configuration of optical fiber connector in the adapter.

At 218 method 200 includes wherein the main body comprises a first snap fit arm and an opposing second snap fit arm, and securing the second configuration of optical fiber connector in the adapter comprises causing the first snap fit arm and the opposing second snap fit arm to secure the second configuration of optical fiber connector in the adapter. At 222 method 200 includes biasing the slider body away from the main body. At 226 method 200 includes wherein a distance between the first snap fit arm and the opposing second snap fit arm is greater than or equal to a width of the first configuration of optical fiber connector.

At 230 method 200 includes, in response to receiving the second configuration of optical fiber connector, moving a slider arm affixed to a slider body toward the main body, thereby causing a first ramp and an opposing second ramp of the slider body to move the first snap fit arm and the opposing second snap fit arm in the main body toward each other to secure the second configuration of optical fiber connector in the adapter. With reference now to FIG. 13B, at 232 method 200 includes biasing the slider body away from the main body. At 234 method 200 includes wherein the slider arm does not contact the first configuration of optical fiber connector when the first configuration of optical fiber connector is inserted into the adapter. At 238 method 200 includes wherein the first configuration of optical fiber connector is a Lucent Connector configuration and the second configuration of optical fiber connector is a Multi-fiber Push On configuration.

At 242 method 200 includes guiding the first configuration of optical fiber connector into the main body using first alignment features on the main body of the adapter. At 246 method 200 includes guiding the second configuration of optical fiber connector into the main body using second alignment features on the main body. At 250 method 200 includes receiving an instrument in an instrument receiving opening defined in a rear side of the main body that is opposite to the front side of the main body.

The following paragraphs provide additional support for the claims of the subject application. One aspect provides an adapter for securing a plurality of configurations of optical fiber connectors, the adapter comprising: a main body; a stop face in the main body that engages with a first configuration of optical fiber connector to secure the first configuration of optical fiber connector in the adapter; and a slider body moveably coupled to the main body; wherein a second configuration of optical fiber connector moves the slider body toward the main body as the second configuration of optical fiber connector is inserted into the main body, thereby securing the second configuration of optical fiber connector in the adapter. The adapter may additionally or alternatively include, wherein one or more biasers extend between the main body and the slider body to bias the slider body away from the main body. The adapter may additionally or alternatively include, wherein the main body comprises a first snap fit arm and opposing second snap fit arm, and a distance between the first snap fit arm and the opposing second snap fit arm is greater than or equal to a width of the first configuration of optical fiber connector. The adapter may additionally or alternatively include, wherein a slider arm is affixed to the slider body, and the second configuration of optical fiber connector moves the slider arm and the slider body toward the main body as the second configuration of optical fiber connector is inserted into the main body, wherein the slider arm does not contact the first configuration of optical fiber connector when the first configuration of optical fiber connector is inserted into the adapter. The adapter may additionally or alternatively include, wherein the first configuration of optical fiber connector is a Lucent Connector configuration and the second configuration of optical fiber connector is a Multi-fiber Push On configuration. The adapter may additionally or alternatively include, wherein the stop face in the main body is a first stop face, and the main body comprises a second stop face that engages with the first configuration of optical fiber connector to secure the first configuration of optical fiber connector in the adapter. The adapter may additionally or alternatively include, wherein the main body comprises first alignment features that guide the first configuration of optical fiber connector into the main body and second alignment features that guide the second configuration of optical fiber connector into the main body. The adapter may additionally or alternatively include, wherein the main body defines a main fiber receiving opening on a front side of the main body, and the main body defines an instrument receiving opening on a rear side opposite to the front side of the main body. The adapter may additionally or alternatively include, wherein the rear side of the main body comprises instrument alignment features configured to guide insertion of an instrument into the rear side. The adapter may additionally or alternatively include a switch to indicate that the second configuration of optical fiber connector is inserted into the main body.

Another aspect provides a method for securing a plurality of configurations of optical fiber connectors into an adapter, the method comprising: receiving a first configuration of optical fiber connector in a front side of a main body of the adapter; in response to receiving the first configuration of optical fiber connector, securing the first configuration of optical fiber connector in the adapter; receiving a second configuration of optical fiber connector in the front side of the main body; and in response to receiving the second configuration of optical fiber connector, securing the second configuration of optical fiber connector in the adapter. The method may additionally or alternatively include, wherein the main body comprises a first snap fit arm and an opposing second snap fit arm, and securing the second configuration of optical fiber connector in the adapter comprises causing the first snap fit arm and the opposing second snap fit arm to secure the second configuration of optical fiber connector in the adapter. The method may additionally or alternatively include, wherein a distance between the first snap fit arm and the opposing second snap fit arm is greater than or equal to a width of the first configuration of optical fiber connector. The method may additionally or alternatively include, in response to receiving the second configuration of optical fiber connector, moving a slider arm affixed to a slider body toward the main body, thereby causing a first ramp and an opposing second ramp of the slider body to move the first snap fit arm and the opposing second snap fit arm in the main body toward each other to secure the second configuration of optical fiber connector in the adapter. The method may additionally or alternatively include biasing the slider body away from the main body. The method may additionally or alternatively include, wherein the slider arm does not contact the first configuration of optical fiber connector when the first configuration of optical fiber connector is inserted into the adapter. The method may additionally or alternatively include, wherein the first configuration of optical fiber connector is a Lucent Connector configuration and the second configuration of optical fiber connector is a Multi-fiber Push On configuration. The method may additionally or alternatively include guiding the first configuration of optical fiber connector into the main body using first alignment features on the main body of the adapter; and guiding the second configuration of optical fiber connector into the main body using second alignment features on the main body. The method may additionally or alternatively include, receiving an instrument in an instrument receiving opening defined in a rear side of the main body that is opposite to the front side of the main body.

Another aspect provides an adapter for securing a plurality of configurations of optical fiber connectors, the adapter comprising: a main body comprising a first snap fit arm and opposing second snap fit arm, the main body defining a main fiber receiving opening on a front side of the main body and an instrument receiving opening on a rear side opposite to the front side; a stop face in the main body that engages with a compliant arm of a first configuration of optical fiber connector to secure the first configuration of optical fiber connector in the adapter; a slider body moveably coupled to the main body with a plurality of biasers extending between the main body and the slider body to bias the slider body away from the main body, the slider body comprising a first ramp and a second ramp opposite the first ramp; and a slider arm affixed to the slider body and extending through an aperture defined in the slider body; wherein as a second configuration of optical fiber connector is inserted into the main body, the second configuration of optical fiber connector moves the slider arm and the slider body toward the main body, thereby causing the first ramp and the opposing second ramp to move the first snap fit arm and the opposing second snap fit arm toward each other, wherein the first snap fit arm and opposing second snap fit arm secure the second configuration of optical fiber connector in the adapter.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. In the descriptions provided herein, ordinal numbers such as first and second are used for convenience and ease of description, and do not denote any order or arrangement of components.

The subject matter of the present disclosure includes all novel and non-obvious combinations and sub-combinations of the various processes, systems and configurations, and other features, functions, acts, and/or properties disclosed herein, as well as any and all equivalents thereof.

1. An adapter for securing a plurality of configurations of optical fiber connectors, the adapter comprising:
a main body;
a stop face in the main body that engages with a first configuration of optical fiber connector to secure the first configuration of optical fiber connector in the adapter; and
a slider body moveably coupled to the main body;
wherein a second configuration of optical fiber connector moves the slider body toward the main body as the second configuration of optical fiber connector is inserted into the main body, thereby securing the second configuration of optical fiber connector in the adapter.

2. The adapter of claim 1, wherein one or more biasers extend between the main body and the slider body to bias the slider body away from the main body.

3. The adapter of claim 1, wherein the main body comprises a first snap fit arm and opposing second snap fit arm, and a distance between the first snap fit arm and the opposing second snap fit arm is greater than or equal to a width of the first configuration of optical fiber connector.

4. The adapter of claim 1, wherein a slider arm is affixed to the slider body, and the second configuration of optical fiber connector moves the slider arm and the slider body toward the main body as the second configuration of optical fiber connector is inserted into the main body, wherein the slider arm does not contact the first configuration of optical fiber connector when the first configuration of optical fiber connector is inserted into the adapter.

5. The adapter of claim 1, wherein the first configuration of optical fiber connector is a Lucent Connector configuration and the second configuration of optical fiber connector is a Multi-fiber Push On configuration.

6. The adapter of claim 1, wherein the stop face in the main body is a first stop face, and the main body comprises a second stop face that engages with the first configuration of optical fiber connector to secure the first configuration of optical fiber connector in the adapter.

7. The adapter of claim 1, wherein the main body comprises first alignment features that guide the first configuration of optical fiber connector into the main body and second alignment features that guide the second configuration of optical fiber connector into the main body.

8. The adapter of claim 1, wherein the main body defines a main fiber receiving opening on a front side of the main body, and the main body defines an instrument receiving opening on a rear side opposite to the front side of the main body.

9. The adapter of claim 8, wherein the rear side of the main body comprises instrument alignment features configured to guide insertion of an instrument into the rear side.

10. The adapter of claim 1, further comprising a switch to indicate that the second configuration of optical fiber connector is inserted into the main body.

11. A method for securing a plurality of configurations of optical fiber connectors into an adapter, the method comprising:
receiving a first configuration of optical fiber connector in a front side of a main body of the adapter;
in response to receiving the first configuration of optical fiber connector, securing the first configuration of optical fiber connector in the adapter;
receiving a second configuration of optical fiber connector in the front side of the main body; and
in response to receiving the second configuration of optical fiber connector, securing the second configuration of optical fiber connector in the adapter.

12. The method of claim 11, wherein the main body comprises a first snap fit arm and an opposing second snap fit arm, and securing the second configuration of optical fiber connector in the adapter comprises causing the first snap fit arm and the opposing second snap fit arm to secure the second configuration of optical fiber connector in the adapter.

13. The method of claim 12, wherein a distance between the first snap fit arm and the opposing second snap fit arm is greater than or equal to a width of the first configuration of optical fiber connector.

14. The method of claim 12, further comprising, in response to receiving the second configuration of optical fiber connector, moving a slider arm affixed to a slider body toward the main body, thereby causing a first ramp and an opposing second ramp of the slider body to move the first snap fit arm and the opposing second snap fit arm in the main body toward each other to secure the second configuration of optical fiber connector in the adapter.

15. The method of claim 14, further comprising biasing the slider body away from the main body.

16. The method of claim 14, wherein the slider arm does not contact the first configuration of optical fiber connector when the first configuration of optical fiber connector is inserted into the adapter.

17. The method of claim 11, wherein the first configuration of optical fiber connector is a Lucent Connector configuration and the second configuration of optical fiber connector is a Multi-fiber Push On configuration.

18. The method of claim 11, further comprising:
guiding the first configuration of optical fiber connector into the main body using first alignment features on the main body of the adapter; and
guiding the second configuration of optical fiber connector into the main body using second alignment features on the main body.

19. The method of claim 11, further comprising receiving an instrument in an instrument receiving opening defined in a rear side of the main body that is opposite to the front side of the main body.

20. An adapter for securing a plurality of configurations of optical fiber connectors, the adapter comprising:
a main body comprising a first snap fit arm and opposing second snap fit arm, the main body defining a main fiber receiving opening on a front side of the main body and an instrument receiving opening on a rear side opposite to the front side;
a stop face in the main body that engages with a compliant arm of a first configuration of optical fiber connector to secure the first configuration of optical fiber connector in the adapter;
a slider body moveably coupled to the main body with a plurality of biasers extending between the main body and the slider body to bias the slider body away from the main body, the slider body comprising a first ramp and a second ramp opposite the first ramp; and
a slider arm affixed to the slider body and extending through an aperture defined in the slider body;
wherein as a second configuration of optical fiber connector is inserted into the main body, the second configuration of optical fiber connector moves the slider arm and the slider body toward the main body, thereby causing the first ramp and the opposing second ramp to move the first snap fit arm and the opposing second snap fit arm toward each other, wherein the first snap fit arm and opposing second snap fit arm secure the second configuration of optical fiber connector in the adapter.
